(19) United States
(12) Patent Application Publication
(10) Pub. No.: US 2013/0059188 A1
(43) Pub. Date: Mar. 7, 2013

(54) BATTERY MOUNTING DEVICE

(71) Applicants: WEN-HU LU, Shenzhen City (CN); PO-WEN CHIU, Tu-Cheng (TW); ZHAN-YANG LI, Shenzhen City (CN)

(72) Inventors: WEN-HU LU, Shenzhen City (CN); PO-WEN CHIU, Tu-Cheng (TW); ZHAN-YANG LI, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/472,581

(22) Filed: May 16, 2012

(30) Foreign Application Priority Data
Sep. 1, 2011 (CN) 201110256769.6

(51) Int. Cl. H01M 2/10

(52) U.S. Cl. 429/100

(57) ABSTRACT

A battery mounting device includes a bracket and case. The bracket includes a rear wall and defines a receiving space. A first latching portion is located on the rear wall. The case includes a front plate opposite to the rear wall. A restricting portion is located on the front plate. The bracket is slidably mounted in the case; the first latching portion is adapted to secure a first end of a battery in the receiving space, and the restricting portion is adapted to secure a second end of the battery in the receiving space.

### BACKGROUND

1. Technical Field

The present disclosure relates to battery mounting devices, and particularly to a battery mounting device in a computer or a server.

2. Description of Related Art

A battery may be used for supplying a working voltage for a plurality of chips, such as CPU, in a computer or a server. The battery is secured to a case, and the case is secured to a chassis of the computer or the server by a plurality of screws. Removal of the battery may be laborious in the above described mounting configuration. Therefore, an improved battery mounting device is desired within the art.

### BRIEF DESCRIPTION OF THE DRAWINGS

Many aspects of the embodiments can be better understood with reference to the drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of one embodiment of a battery mounting device and two batteries.

FIG. 2 shows the objects of FIG. 1 viewed from another aspect.

FIG. 3 is an isometric view of a partial assembly of the battery mounting device and the two batteries of FIG. 1.

FIG. 4 is an assembled, isometric view of the battery mounting device and the two batteries of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

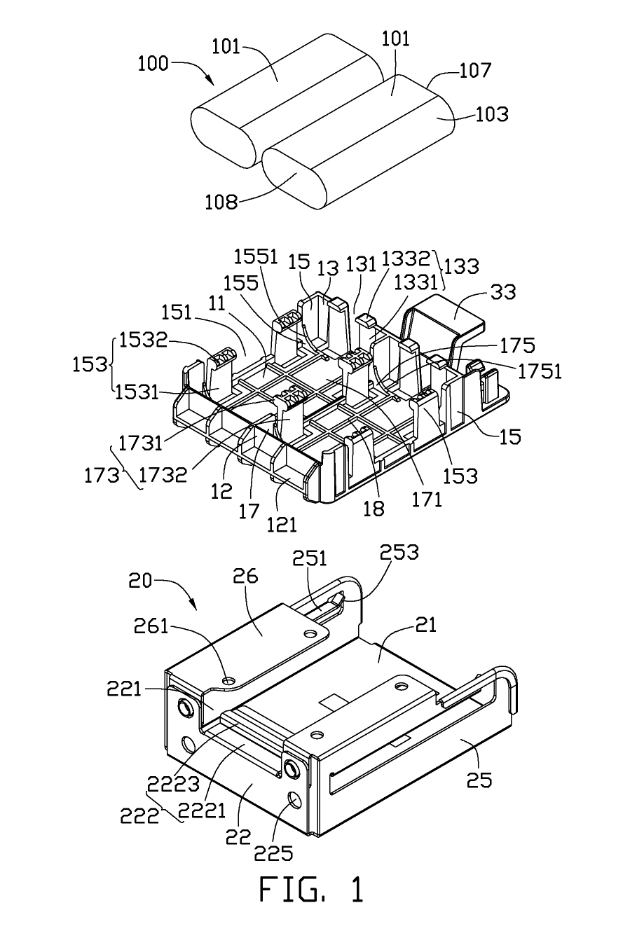

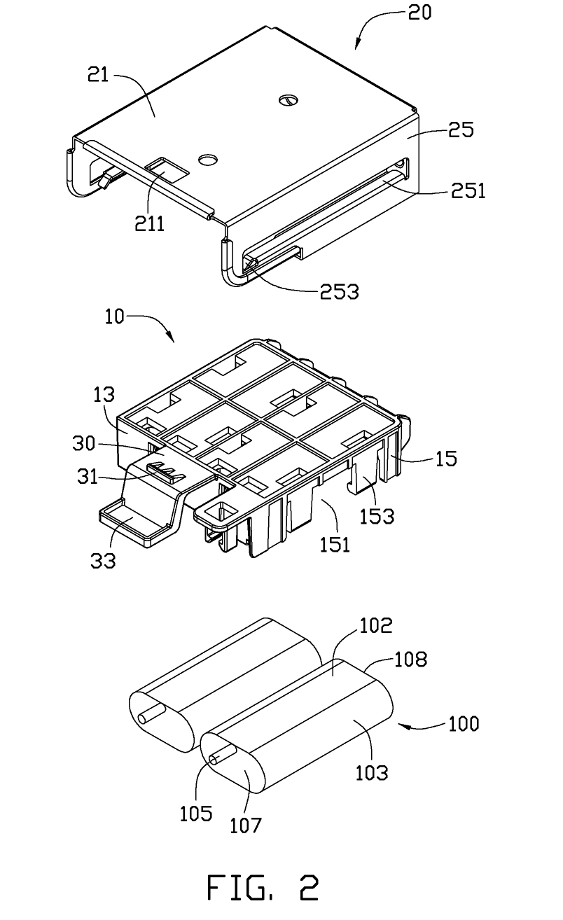

FIG. 1 and FIG. 2 show a battery mounting device in accordance with an embodiment, for mounting two batteries 100. The battery mounting device includes a bracket 10 and a case 20.

Each of the two batteries 100 includes a top surface 101, a bottom surface 102, and two side surfaces 103 connected to the top surface 101 and the bottom surface 102. Each of the two batteries 100 includes a first end 107 and a second end 108. A cable 105 is connected to the first end 107. In one embodiment, the top surface 101 is substantially parallel to the bottom surface 102, and each of the two side surfaces 103 is curved.

The bracket 10 includes a bottom wall 11, a front wall 12, a rear wall 13, and two sidewalls 15. In one embodiment, the bottom wall 11 is substantially perpendicular to each of the front wall 12, the rear wall 13 and the two sidewalls 15, the front wall 12 is substantially parallel to the rear wall 13, and the two sidewalls 15 are substantially parallel to each other. A resisting portion 121 extends from an outer surface of the front wall 12. A baffle plate 17 is located between the two sidewalls 15 and substantially parallel to each of the two sidewalls 15. The baffle plate 17 is connected to the bottom wall 11, the front wall 12 and the rear wall 13. The bracket 10 defines two receiving spaces 18. Each of the two receiving spaces 18 is defined corporately by the bottom wall 11, the front wall 12, the rear wall 13, the baffle plate 17 and each of the two sidewalls 15.

The rear wall 13 defines a first cutout 131 in each of the two receiving spaces 18. A first latching portion 133 extends from each of two opposite side edges of first cutout 131. The first latching portion 133 includes a first limiting piece 1331 and a first latching block 1332. The first limiting piece 1331 is connected to the bottom wall 11. The first latching block 1332 extends from the first limiting piece 1331. The first latching block 1332 extends towards the front wall 12 and out of a top edge of the rear wall 13. Each of the two sidewalls 15 defines a second cutout 151. A first resisting piece 155 extends inwards from each of two opposite side edges of the second cutout 151. In one embodiment, the first resisting piece 155 is substantially perpendicular to each of the two sidewalls 15. The first resisting piece 155 includes a first resisting surface 1551, and the first resisting surface 1551 is curved. Two second latching portions 153 extend from the bottom wall 11 and are located in the second cutout 151. Each of the two second latching portions 153 includes a second limiting piece 1531 and a second latching block 1532. The second latching block 1532 extends inwards from a top edge of the second limiting piece 1531. In one embodiment, the second latching block 1532 is curved. The baffle plate 17 defines a third cutout 171. A second resisting piece 175 extends inwards from each of two opposite side edges of the third cutout 171. In one embodiment, the second resisting piece 175 is substantially perpendicular to the bottom wall 11 and the two sidewalls 15. The second resisting piece 175 includes a second resisting surface 1751, and the second resisting surface 1751 is curved. Two third latching portions 173 extend from the bottom wall 11 and are located in the third cutout 171. Each of the two third latching portions 173 includes a third limiting piece 1731 and a third latching block 1732. The third latching block 1732 extends inwards from a top edge of the third limiting piece 1731. In one embodiment, the third latching block 1732 is curved.

The bracket 10 further includes a positioning portion 30 and an operating portion 33. The positioning portion 30 extends outwards from a bottom edge of the rear wall 13. The positioning portion 30 is elastically deformable. A positioning block 31 extends from a bottom surface of the positioning portion 30. The operating portion 33 extends from the positioning portion 30 and elastically deforms the positioning portion 30. In one embodiment, the positioning portion 30 is substantially perpendicular to the rear wall 13, and the operating portion 33 has substantially an “L” shape.

The case 20 includes a bottom plate 21, a front plate 22, and two side plates 25. In one embodiment, the bottom plate 21 is substantially perpendicular to the front plate 22 and the two side plates 25, and the two side plates 25 are substantially parallel to each other. The bottom plate defines a positioning hole 211. The front plate 22 defines a cutout 221. A restricting portion 222 extends from a bottom edge of the positioning hole 211. The restricting portion 222 includes a first restricting piece 2221 and a second restricting piece 2223. The first restricting piece 2221 is substantially perpendicularly connected to the front plate 22. The second restricting piece 2223 extends from the first restricting piece 2221. In one embodiment, the second restricting piece 2223 has an “L” shape. The front plate 22 defines two first locking holes 225. A mounting piece 251 extends from an inner surface of each of the two side plates 25. In one embodiment, the mounting piece 251 is substantially perpendicular to each of the two side plates 25. An installation piece 253 extends obliquely upwards from an end of the mounting piece 251. A locking plate 26 extends inwards from a top edge of each of the two side plates 25. In one embodiment, the locking plate 26 defines two second locking holes 261. The first locking hole 225 and the second locking hole 261 are adapted for a locking member, such as a screw, to pass through, to secure the case 20.

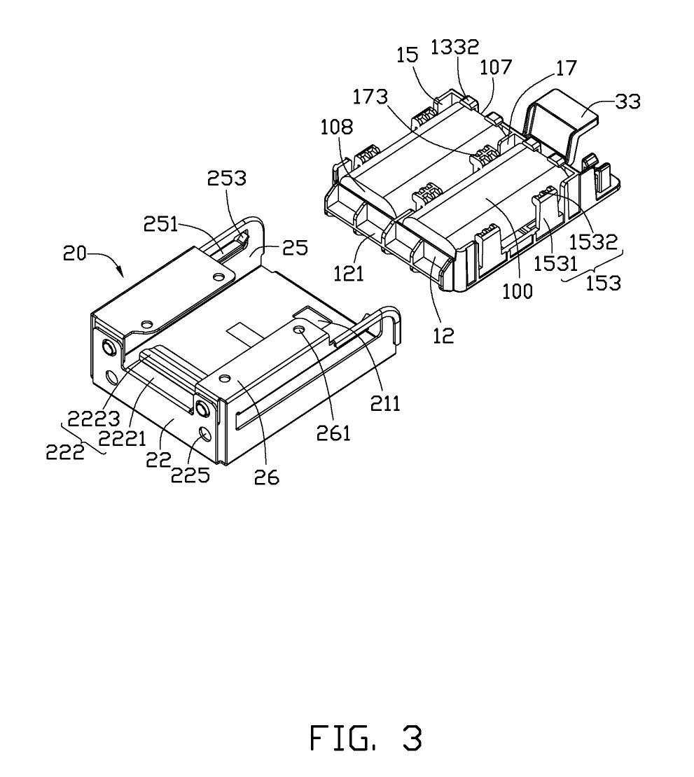

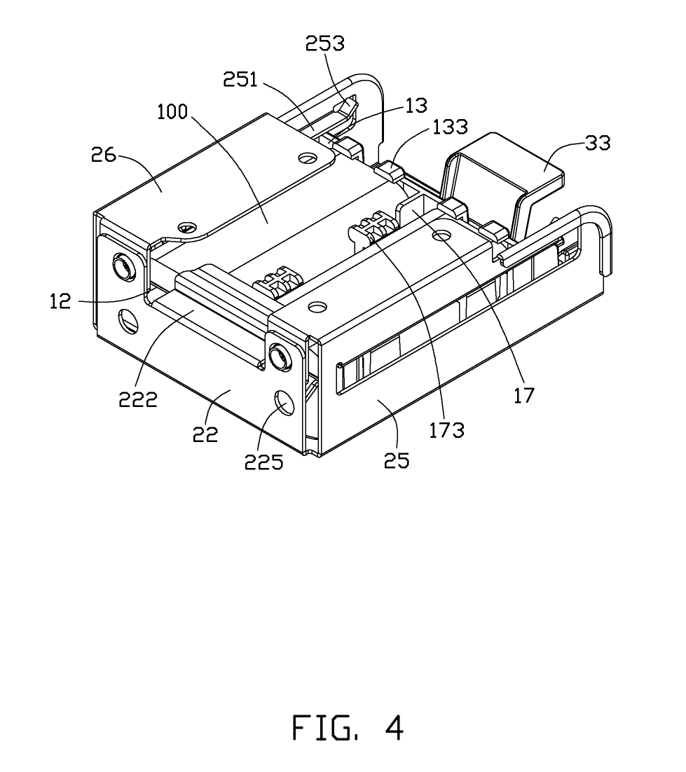

FIG. 3 and FIG. 4 show that, in assembly, each of the two batteries 100 is placed into each of the two receiving spaces 18. The top surface 101 of the first end 107 abuts the first latching block 1332. The cable 105 extends out of the bracket 10 through the first cutout 131, to supply electrical power as required. The first resisting surface 1551 and the second resisting surface 1751 abut the two side surfaces 103. Each of the two second latching portions 153 and each of the two third latching portions 173 are elastically deformed and exert an elastic force to secure each of the two batteries 100 therebetween, to prevent each of the two batteries 100 from moving along a first direction substantially parallel to the bottom wall 11. The front wall 12 and the first limiting piece 1331 prevent each of the two batteries 100 from moving along a second direction substantially parallel to the bottom wall 11, and the second direction is substantially perpendicular to the first direction. The first latching block 1332 and the bottom wall 11 prevent each of the two batteries 100 from moving along a third direction substantially perpendicular to the bottom wall 11, and the third direction is substantially perpendicular to the first direction and the second direction.

The bracket 10 is to be coupled with the case 20, and the resisting portion 121 is located adjacent to the installation piece 253. The bracket 10 is slid towards the front plate 22 between the mounting piece 251 and the bottom plate 21, until the second end 108 is blocked by the second restricting piece 2223. The bracket 10 is further moved, the second restricting piece 2223 is elastically deformed upwards, and the positioning portion 30 is elastically deformed upwards on being blocked by the bottom plate21, until the bracket 10 abuts the front plate 22 and the positioning block 31 is aligned with the positioning hole 211. The second restricting piece 2223 exerts an elastic force against the second end 108. The positioning portion 30 rebounds to engage the positioning block 31 in the positioning hole 211. In this position, the first restricting piece 2221 abuts a top edge of the front wall 12. The resisting portion 121 is secured between the first restricting piece 2221 and the bottom plate 21.

In disassembly, the operating portion 33 is pulled away from the bottom plate 21, to disengage the positioning block 31 from the positioning hole 211, and then the bracket 10 is slid away from the front plate 22, to be removed from the case 20. The second end 108 of the battery 100 is moved upwards to elastically deform each of the two second latching portions 153 and each of the two third latching portions 173, and then the battery 100 can be removed from the bracket 10.

It is to be understood, however, that even though numerous characteristics and advantages of the embodiments have been set forth in the foregoing description, together with details of the structure and function of the embodiments, the disclosure is illustrative only, and changes may be made in detail, especially in the matters of shape, size, and arrangement of parts within the principles of the invention to the full extent indicated by the broad general meaning of the terms in which the appended claims are expressed.

What is claimed is:

1. A battery mounting device, comprising:
a bracket comprising a rear wall and defining a receiving space, and a first latching portion located on the rear wall; and
a case comprising a front plate opposite to the rear wall, and a restricting portion located on the front plate;
wherein the bracket is slidably mounted in the case; the first latching portion is adapted to secure a first end of a battery in the receiving space, and the restricting portion is adapted to secure a second end of the battery in the receiving space, and the second end is opposite to the first end.

2. The battery mounting device of claim 1, wherein the bracket further comprises a bottom wall and a front wall, the bottom wall is substantially perpendicular to the rear wall, and the front wall is substantially parallel to the rear wall; the first latching portion comprises a first limiting piece and a first latching block; the first latching block is opposite to the restricting portion, and the first latching block and the restricting portion are adapted to secured the battery therebetween and to prevent the battery from moving along a first direction substantially perpendicular to the bottom wall; the first limiting piece is opposite to the front wall, and the first limiting piece and the front wall are adapted to secured the battery therebetween and to prevent the battery from moving along a second direction substantially parallel to the bottom wall.

3. The battery mounting device of claim 2, wherein a second latching portion and a third latching portion extend from the bottom wall, and the second latching portion is opposite to the third latching portion; and the second latching portion and the third latching portion are adapted to abut two opposite sides of the battery and to prevent the battery from moving along a third direction, the third direction being substantially parallel to the bottom wall and perpendicular to the first direction and the second direction.

4. The battery mounting device of claim 3, wherein the second latching portion comprises a second latching block, and the third latching portion comprises a third latching block; each of the second latching block and the third latching block comprises a curved latching surface, and the curved latching surface is configured to abut a curved side surface of the battery.

5. The battery mounting device of claim 4, wherein a resisting piece extends from the bottom wall, and the resisting piece is substantially perpendicular to the bottom wall; the resisting piece comprises a curved resisting surface, and the curved resisting surface is configured to abut the curved side surface of the battery.

6. The battery mounting device of claim 2, wherein the case further comprises a bottom plate, and the bottom plate is substantially perpendicular to the front plate; the restricting portion comprises a first restricting piece and a second restricting piece, the first restricting piece is connected to the front plate, and the second restricting piece is connected to the first restricting piece; a resisting portion extends from the front wall, and the resisting portion is located between the front wall and the front plate and received between the first restricting piece and the bottom plate.

7. The battery mounting device of claim 6, wherein the first restricting piece abuts a top edge of the front wall, and the second restricting piece is adapted to abut the second end the battery.

8. The battery mounting device of claim 6, wherein the case further comprises a side plate, and the side plate is substantially perpendicular to the bottom plate; a mounting piece extends from the side plate, and the mounting piece is substantially parallel to the bottom plate; the bracket is slidably received between the mounting piece and the bottom plate.

9. The battery mounting device of claim 8, wherein a locking plate extends from the side plate, and the locking plate is substantially parallel to the bottom plate; each of the front plate and the locking plate defines a locking hole, and the case is secured through the locking hole.

10. The battery mounting device of claim 6, wherein the bottom plate defines a positioning hole; the bracket further comprises a positioning portion and an operating portion, the positioning portion comprises a positioning block, and the operating portion extends from the positioning portion; the positioning block is engaged in the positioning hole; and the positioning portion is elastically deformable by the operating portion thereby disengaging the positioning block from the positioning hole.

11. A battery mounting device, comprising:
a bracket comprising a rear wall, a bottom wall and a front wall, the bottom wall is substantially perpendicular to the rear wall, and the front wall is substantially parallel to the rear wall; the bracket defining a receiving space, and a first latching portion located on the rear wall and comprising a first limiting piece and a first latching block, the first limiting piece extending from the bottom wall, and the first latching block extends from the first limiting piece; and
a case comprising a front plate opposite to the rear wall, and the a restricting portion located on the front plate;
wherein the bracket is slidably mounted in the case; the first latching portion is adapted to secure a first end of a battery in the receiving space, and the restricting portion is adapted to secure a second end of the battery in the receiving space that is opposite to the first end; the first latching block is opposite to the restricting portion, and the latching block and the restricting portion are adapted to secured the battery therebetween and to prevent the battery from moving along a first direction substantially perpendicular to the bottom wall; the first limiting piece is opposite to the front wall, and the first limiting piece and the front wall are adapted to secured the battery therebetween and to prevent the battery from moving along a second direction substantially parallel to the bottom wall.

12. The battery mounting device of claim 11, wherein a second latching portion and a third latching portion extend from the bottom wall, and the second latching portion is opposite to the third latching portion; and the second latching portion and the third latching portion are adapted to abut two opposite sides of the battery and prevent the battery from moving along a third direction, the third direction being substantially parallel to the bottom wall and perpendicular to the first direction and the second direction.

13. The battery mounting device of claim 12, wherein the second latching portion comprises a second latching block, and the third latching portion comprises a third latching block; each of the second latching block and the third latching block comprises a curved latching surface, and the curved latching surface is configured to abut a curved side surface of the battery.

14. The battery mounting device of claim 13, wherein a resisting piece extends from the bottom wall, and the resisting piece is substantially perpendicular to the bottom wall; the resisting piece comprises a curved resisting surface, and the curved resisting surface is configured to abut the curved side surface of the battery.

15. The battery mounting device of claim 11, wherein the case further comprises a bottom plate, and the bottom plate is substantially perpendicular to the front plate; the restricting portion comprises a first restricting piece and a second restricting piece, the first restricting piece is connected to the front plate, and the second restricting piece is connected to the first restricting piece; a resisting portion extends from the front wall, and the resisting portion is located between the front wall and the front plate and received between the first restricting piece and the bottom plate.

16. The battery mounting device of claim 15, wherein the first restricting piece abuts a top edge of the front wall, and the second restricting piece is adapted to abut the second end the battery.

17. The battery mounting device of claim 15, wherein the case further comprises a side plate, and the side plate is substantially perpendicular to the bottom plate; a mounting piece extends from the side plate, and the mounting piece is substantially parallel to the bottom plate; the bracket is slidably received between the mounting piece and the bottom plate.

18. The battery mounting device of claim 17, wherein an installation piece extends obliquely from an end of the mounting piece away from the bottom plate, and the installation piece is operable to slidably receive the bracket.

19. The battery mounting device of claim 17, wherein a locking plate extends from the side plate, and the locking plate is substantially parallel to the bottom plate; each of the front plate and the locking plate defines a locking hole, and the case is secured through the locking hole.

20. The battery mounting device of claim 15, wherein the bottom plate defines a positioning hole; the bracket further comprises a positioning portion and an operating portion, the positioning portion comprises a positioning block, and the operating portion extends from the positioning portion; the positioning block is engaged in the positioning hole; and the positioning portion is elastically deformable by the operating portion thereby disengaging the positioning block from the positioning hole.
